(19) United States
(12) Patent Application Publication
(10) Pub. No.: US 2026/0266637 A1
(43) Pub. Date: Sep. 10, 2026

(54) APPARATUS AND METHOD FOR MEASURING VALUE OF MULTIMODAL DATA BASED ON UNIT DATA CHARACTERISTICS

(71) Applicant: Korea Electronics Technology Institute, Seongnam-si (KR)

(72) Inventors: Seungwoo KUM, Yongin-si (KR); Jaewon MOON, Seoul (KR); Seungtaek OH, Seongnam-si (KR)

(21) Appl. No.: 19/234,096

(22) Filed: Jun. 10, 2025

(30) Foreign Application Priority Data
Mar. 4, 2025 (KR) 10-2025-0027745

(51) Int. Cl. G01D 21/02

(52) U.S. Cl. CPC G01D 21/02

(57) ABSTRACT

Proposed are an apparatus and a method for measuring value of multimodal data based on characteristics of unit data. The apparatus may include a data separation processor configured to separate pieces of unit data from an input multimodal dataset. The apparatus may also include a data value measurement processor configured to evaluate a quality index of each piece of unit data based on preset criteria, and calculate a value index of each piece of unit data based on the preset criteria depending on the quality index of each piece of unit data. The apparatus may further include a weight application processor configured to calculate final data value by applying a weight to the value index of each piece of unit data calculated by the data value measurement processor, thus measuring the value of the multimodal data based on the characteristics of the unit data.

### CROSS-REFERENCE TO RELATED APPLICATION

The present application claims priority to and the benefit of Korean Patent Application No. 10-2025-0027745, filed on Mar. 4, 2025, in the Korean Intellectual Property Office, the entire disclosure of which is incorporated herein by reference.

### BACKGROUND

### Technical Field

The present disclosure relates to technology for measuring the value of data, and more particularly to technology for measuring the value of a single dataset composed of multiple modalities based on data characteristics thereof depending on the purpose of use of data.

### Discussion of Related Technology

For data quality management, international standards and related standards/techniques are being developed through the ISO-8000 series or the like. These international standards and related standards/techniques for data quality management refer to regular management of data, and particularly include aspects concerning the integrity or value judgement of training data. However, value judgement techniques corresponding to the purpose of using each piece of data are continuously demanded to promote the activation of artificial intelligence services.

### SUMMARY

One aspect is a method for calculating the value of multimodal data as a weighted sum based on the characteristics of respective pieces of unit data.

Another aspect is a scheme for measuring the value of actual data used for inference as well as training data.

Another aspect is to quantify the value of data validity by quantitatively defining the quality of data itself (e.g., image quality, text quality, or the like).

The aspects of the present disclosure are not limited to those described herein, and other aspects not explicitly stated will be clearly understood by those skilled in the art from the following description.

Another aspect is an apparatus for measuring value of multimodal data based on unit data characteristics. The apparatus may include a data separation unit configured to separate pieces of unit data from an input multimodal dataset, a data value measurement unit configured to evaluate a quality index of each piece of unit data based on the first preset criteria, and calculate a value index of each piece of unit data based on the second preset criteria depending on the quality index of each piece of unit data, and a weight application unit configured to calculate final data value by applying a weight to the value index of each piece of unit data calculated by the data value measurement unit.

Another aspect is a method for measuring value of multimodal data based on unit data characteristics. The method may include separating pieces of unit data from an input multimodal dataset, evaluating a quality index of each piece of unit data based on the first preset criteria, calculating a value index of each piece of unit data based on the second preset criteria depending on the quality index of each piece of unit data, and calculating final data value by applying a weight to the value index of each piece of unit data.

Embodiments disclosed in the present disclosure are advantageous in that they may be applied as methods for not only verifying the quality of training data but also verifying the value of data used for inference.

Further, embodiments of the present disclosure are advantageous in that the validity and value of multimodal data desired to be analyzed by artificial intelligence may be quantitatively measured.

Furthermore, the embodiments disclosed in the present disclosure are advantageous in that the validity of training data for creating an artificial intelligence model may be quantitatively measured.

Furthermore, the embodiments disclosed in the present disclosure are advantageous in that they may contribute to the improvement of artificial intelligence training and operation performance.

Meanwhile, the effects of the present disclosure are not limited to the above-mentioned effects, and other effects not explicitly stated may be easily understood by those skilled in the art from the following description.

### BRIEF DESCRIPTION OF THE DRAWINGS

The following drawings attached to this specification illustrate preferred embodiments of the present disclosure, and help to further understand the technical spirit of the present disclosure along with the aforementioned contents of the disclosure. Accordingly, the present disclosure should not be construed as being limited to only contents described in such drawings.

FIG. 1 illustrates an example of a normal computing device capable of functioning as an apparatus for measuring the value of multimodal data according to an embodiment.

FIG. 2 is a diagram for explaining an AI processing unit applied to an apparatus for measuring the value of multimodal data according to an embodiment of the present disclosure.

FIG. 3 is a functional block diagram illustrating an apparatus for measuring the value of multimodal data according to an embodiment.

FIG. 4 is a diagram for explaining a method for measuring the value of multimodal data, performed by an apparatus for measuring the value of multimodal data, according to an embodiment.

### DETAILED DESCRIPTION

In the case of data quality management, various standards are developed with the aim of managing the quality of training data. Standards aimed at managing the quality of the training data emphasize the integrity of data in datasets and define that the configuration of data for training needs to be well-structured. For example, the public data quality management manual published by the National Information Society Agency (NIA) of Korea defines a formula for calculating the quality error rate of training data, as shown in the following <Equation>. The quality error rate of an individual database (DB) is calculated as the sum of values obtained by applying weights for respective elements to the error rates of respective quality elements (value, structure, and standard).

However, in conventional technologies, access paths of each node to services need to be manually and individually configured and managed. Administrators are required to manually configure NodePort information for each node and services and provide the configured information to external users. As a result, the complexity of management increases and the possibility of errors occurring also increases. Furthermore, users need to personally obtain the NodePort information, thus resulting in difficulty in use. These issues can occur even within a single cluster, and especially in large-scale environments where multiple clusters are to be managed, difficulties are even greater.

$$Quality error rate ( \% ) = {\sum }_{i = 1}^{n} ( {E}_{i} \times {W}_{i} ) \qquad Equation$$

Here, E denotes an error rate for quality element, and W denotes a weight for each quality element.

Among the quality elements, value (accuracy) error rate E₁ refers to an error level for the value of the corresponding database (DB), as measured through quality diagnosis. Among the quality elements, structure (completeness) error rate E₂ refers to the degree to which the structure of the corresponding DB is incomplete, as measured through quality diagnosis. Among the quality elements, standard (consistency) error rate E₃ refers to the level to which the relevant database (DB) falls short in complying with standards, as identified through quality diagnosis.

The quality error rate calculation formula defines the accuracy of values, completeness of the structure, and consistency of standards for training data as a weighted sum. This is intended to determine whether public data generated for training purposes does not contain outliers, whether the public data provides well-structured training data, whether the public data properly complies with the standards, or the like.

Although the quality error rate calculation formula, or a data management technique presented in ISO-8000 or the like, is highly useful for verifying the configuration of training data, it is not easily applicable to quality judgement of multimodal data or value judgement of actual inference data. In the case of multimodal data, since various types of data such as images and text are configured and utilized as a single dataset, there are problems such as the need for the above-described calculation formula to be more complexly extended and a problem in which it is not possible to structurally define problems in actual data.

For example, in the case of image data, it is possible to verify data quality in training data configuration through ISO-8000, but it is not easy to verify the quality of images actually used for inference. Taking object detection as an example, when the performance of the result of object detection is low, the cause thereof may lie in an object detection model. However, actually, performance degradation may occur due to the quality of the original image input to an object detection model to detect an object.

In a detailed example, in the result of inferring multimodal data composed of images and text, the influence of the quality of original data may be determined. In an example of a multimodal artificial intelligence (AI) model that receives images of crowded pictures (scenes) from a specific website, along with related SNS posts, as input and performs analysis, even if the AI model itself has been trained to exhibit high performance, the result of analysis may not exhibit high performance when the actual input image is blurry or text is abnormal. In this case, it is necessary to have an index to determine whether the AI model itself has a problem or whether temporary performance degradation occurs due to the input of unreliable data.

It should be noted that the technical terms used in the present disclosure are merely for the purpose of describing specific embodiments, and are not intended to limit the scope of the technical spirits disclosed herein. Further, unless otherwise defined herein, the technical terms used in the present disclosure should be interpreted in accordance with generally accepted meanings as understood by those of ordinary skill in the art to which the present disclosure pertains, and should not be construed in an excessively broad or excessively narrow sense. Furthermore, if any of the technical terms used in this specification fail to accurately reflect the technical spirit disclosed herein, such terms should be interpreted and replaced with technical terms that can be properly understood by those of ordinary skill in the art to which the present disclosure pertains. Also, general terms used in this specification should be interpreted according to definitions provided in dictionaries or based on the context in which they are used, and should not be interpreted in an unduly narrow sense.

The embodiments disclosed in this specification will now be described in detail with reference to the accompanying drawings. In the drawings, the same or similar components are denoted by the same reference numerals regardless of the drawings, and redundant descriptions thereof will be omitted. The suffixes “module” and “unit” used for components described in the following embodiments are used merely for convenience in preparing the specification and do not imply any distinct meanings or roles by themselves. The accompanying drawings are provided solely for the purpose of facilitating an understanding of the disclosed embodiments and should not be construed as limiting the technical spirit disclosed herein. It is to be understood that various modifications, equivalents, and substitutions may be made without departing from the spirit and scope of the present disclosure.

Although terms including ordinal numbers such as “first” and “second” used in the present disclosure may be used herein to describe various elements, the elements should not be limited by these terms. These terms are only used to distinguish one component from other components. For example, a first component may be referred to as a second component without departing from the teachings of the present disclosure. Similarly, the second component may be referred to as a first component without departing from the scope of the present disclosure.

It will be understood that when an element is referred to as being “coupled” or “connected” to another element, it can be directly coupled or connected to the other element, but intervening elements may be present therebetween. In contrast, it should be understood that when an element is referred to as being “directly coupled” or “directly connected” to another element, there are no intervening elements therebetween.

A singular expression includes a plural expression unless a description to the contrary is specifically pointed out in context.

It should be further understood that the terms “comprise”, “include”, and “have” when used in this specification, specify the presence of stated features, integers, steps, operations, elements, components, and/or combinations thereof but do not preclude the presence or addition of one or more other features, integers, steps, operations, elements, components, and/or combinations thereof.

The present disclosure may enable a prior determination of how valuable the multimodal data composed of combinations of various types of data is for use in analysis. In the case of normal data, the performance of analysis results may vary depending on the quality of the data itself (e.g., differences in clarity or resolution for image data, presence or absence of noise for audio data, and presence or absence of typos, slang, or vulgar expressions for text data). Since multimodal data is a combination of multiple types of data, such performance differences may be even greater. Generally, the quality of data is checked in a training phase, but such quality definition is not present during inference. Moreover, even in the case of training data, only the quality of the training data is checked, but the validity of the data is not defined.

The present disclosure proposes a technique for determining the value of data in terms of how valid the data is before the data is analyzed. This process is implemented as a combination of various analytical techniques applied to each of pieces of unit data that constitutes the multimodal data, and is calculated as a weighted sum of unit value scores extracted from respective pieces of unit data. By means of this method, the multimodal data may have an index that can quantitatively represent how valid it is for analysis, and may be used as data available for interpretation of analysis results.

Hereinafter, embodiments of the present disclosure will be described in detail with reference to the attached drawings.

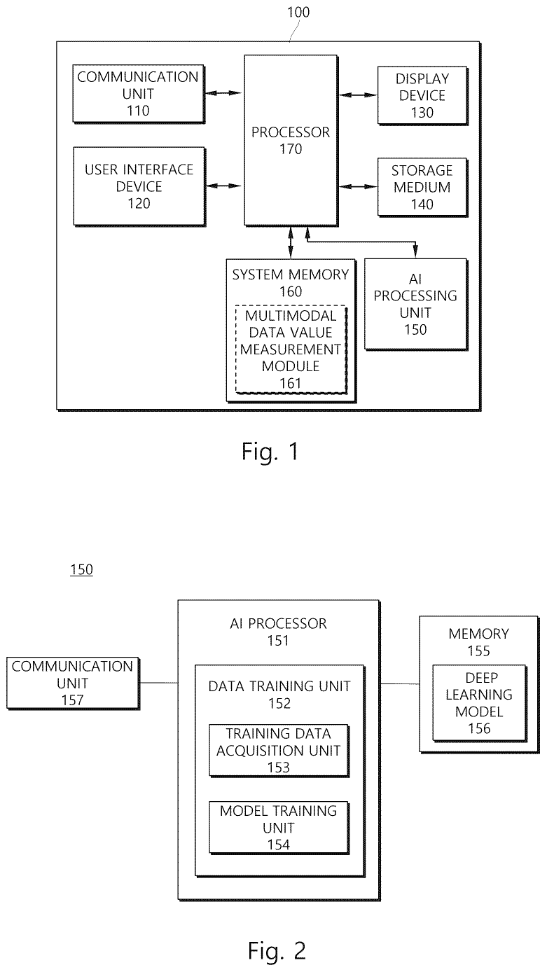

FIG. 1 illustrates an example of a normal computing device capable of functioning as an apparatus for measuring the value of multimodal data according to an embodiment.

Referring to FIG. 1, a computing device 100 may be configured to include a communication unit 110, a user interface device 120, a display device 130, a storage medium 140, an Artificial Intelligence (AI) processing unit 150, a system memory 160, and a processor 170. The illustrated components may not be essential, and thus a computing device including more components or fewer components than those illustrated in the drawing may also be implemented. Such components may be implemented with hardware or software, or with a combination of hardware and software.

The communication unit 110 may transmit and receive signals between the computing device 100 and a multimodal data collection device or devices through which the multimodal data is input, over a network.

The user interface device 120 receives user input for controlling the operations of the computing device 100 or the processor 170. The user interface device 120 may include a keypad, a dome switch, a touch pad (resistive/capacitive type), a jog wheel, a jog switch, a finger mouse, and the like.

The display device 130 operates in response to the control of the processor 170. The display device 130 displays information processed by the computing device 100 or the processor 170. For example, the display device 130 may display an image or text or display the results of value assessment calculation of such data, under the control of the processor 170.

The storage medium 140 may be at least one of a flash memory, a hard disk, a Solid State Disk (SSD), a multimedia card memory, a random access memory (RAM), a static random access memory (SRAM), read-only memory (ROM), electrically erasable programmable read-only memory (EEPROM), programmable read-only memory (PROM), a magnetic memory, a magnetic disk, or an optical disk. The storage medium 140 is configured to write or read data under the control of the processor 170.

The processor 170 may include either a general-purpose processor or a dedicated processor, and may control the operations of the communication unit 110, the user interface device 120, the display device 130, the storage medium 140, the AI processing unit 150, and the system memory 160.

The processor 170 may be configured to load program codes including instructions for providing various functions from the storage medium 140 into the system memory 160 when executed, and to execute the loaded program codes. The processor 170 may load a multimodal data value measurement module 161 that includes instructions and/or program codes from the storage medium 140 into the system memory 160, and may execute the loaded multimodal data value measurement module 161. The multimodal data value measurement module 161 may display an input image or text on the display device 130, and may detect related user input. Also, the multimodal data value measurement module 161 may visualize an additional user interface on the display device 130, and may detect user input through the visualized user interface.

The processor 170 may implement all functions of the computing device 100, described with reference to FIG. 1, and all processes of a method for measuring the value of multimodal data by the computing device 100, through the multimodal data value measurement module 161 loaded from the storage medium 140.

The system memory 160 may be provided as a working memory of the processor 170. Although the system memory 160 is illustrated as a component separate from the processor 170 in the drawing, this is merely exemplary, and at least a portion of the system memory 160 may be integrated into the processor 170. The system memory 160 may include at least one of a random access memory (RAM), a read-only memory (ROM), and other types of computer-readable storage media.

The AI processing unit 150 may be configured to process a multimodal dataset including images, audio, text, and the like based on artificial intelligence, and may execute generative artificial intelligence for measuring the value of the multimodal dataset, for example, a large language model or a computer vision-based image analysis algorithm, according to an embodiment of the present disclosure. The AI processing unit 150 may be implemented as a single module integrated with the processor 170, which controls the overall system, or as an independent module separated from the processor 170. The AI processing unit 150 may be implemented as an independent module or device separated from the computing device 100. The AI processing unit 150 may train a generative artificial intelligence model to perform data analysis and value assessment on various types of multimodal data, and may also assist in data processing during a process in which the multimodal data value measurement module 161 measures value based on the input multimodal data.

FIG. 2 is a diagram for explaining an AI processing unit applied to an apparatus for measuring the value of multimodal data according to an embodiment of the present disclosure.

Referring to FIG. 2, an AI processing process by the AI processing unit 150 may include all operations related to the processor of the apparatus for measuring the value of multimodal data. For example, the AI processing unit 150 may perform processing/determination and control signal generation operations by performing AI processing on an acquired image signal.

The AI processing unit 150 may be a client device that directly uses the result of AI processing, or a device in a cloud environment that provides the result of AI processing to other devices. The AI processing unit 150, which is a computing device that can train a neural network, may be implemented as various electronic devices such as an AI chip, an AI module, a server, a desktop PC, a notebook PC, a tablet PC, or a smart pad.

The AI processing unit 150 may include an AI processor 151, a memory 155, and a communication unit 157.

The AI processor 151 may train a generative artificial intelligence neural network using a program stored in a memory 155. In particular, the AI processor 151 may train a neural network for recognizing data related to the value measurement of multimodal data. Here, the neural network for recognizing the multimodal data may be designed to simulate the structure of the human brain on a computer, and may include a plurality of network nodes with weights that mimic the neurons of a human nervous system. The plurality of network nodes may exchange data with each other depending on connecting relationships therebetween to simulate the synaptic activity of neurons that exchange signals through synapses. Here, the neural network may include a deep learning model developed from a neural network model. In the deep learning model, the plurality of network nodes may exchange data with each other depending on convolutional connection relationships while being located in different layers. Examples of the neural network model may include various deep learning techniques such as Deep Neural Networks (DNN), Convolutional Deep Neural Networks (CNN), Recurrent Neural Networks (RNN), Restricted Boltzmann Machine (RBM), Deep Belief Networks (DBN), or deep Q-networks, and may be applied to fields such as computer vision (CV), speech recognition, natural language processing, and audio/signal processing.

Meanwhile, although the AI processor that performs the foregoing functions may be a general-purpose processor (e.g., Central Processing Unit: CPU), it may be a dedicated AI processor (e.g., Graphics Processing Unit: GPU or Neural Processing Unit: NPU) for AI training.

The memory 155 may store various types of programs and data required for the operation of the AI processing unit 150. The memory 155 may be implemented as a nonvolatile memory, a volatile memory, a flash memory, a Hard Disk Drive (HDD) or a Solid State Drive (SDD). The memory 155 may be accessed by the AI processor 151, and may be subjected to data reading/writing/modification/deletion/update or the like by the AI processor 151. Further, the memory 155 may store a neural network model (e.g., a deep learning model 156) generated through a learning algorithm for data classification/recognition according to an embodiment of the present disclosure.

Meanwhile, the AI processor 151 may include a data training unit 152 that trains the neural network for data classification/recognition. The data training unit 152 may train criteria based on which training data is to be used to determine data classification/recognition and how data is to be classified and recognized based on the training data. The data learning unit 152 may train the deep learning model by acquiring training data to be used for training and by applying the acquired training data to the deep learning model.

The data training unit 152 may be manufactured in the form of at least one hardware chip, and may be mounted in the AI processing unit 150. For example, the data training unit 152 may be manufactured in the form of a dedicated hardware chip for artificial intelligence (AI), and may be manufactured as a portion of the general-purpose processor (e.g., CPU) or a dedicated graphics processor (e.g., GPU) and then mounted in the AI processing unit 150. Furthermore, the data training unit 152 may be implemented as a software module. When the data training unit 152 is implemented as a software module (or a program module including instructions), the software module may be stored in non-transitory computer-readable media. In this case, at least one software module may be provided either by an Operating System (OS) or by an application.

The data training unit 152 may include a training data acquisition unit 153 and a model training unit 154.

The training data acquisition unit 153 may acquire training data required for a neural network model for classifying and recognizing data.

The model training unit 154 may train the neural network model to have determination criteria related to how the neural network model will classify certain data based on the acquired training data. Here, the model training unit 154 may train the neural network model through supervised learning that adopts at least a portion of the training data as the determination criteria. Alternatively, the model training unit 154 may train the neural network model through unsupervised learning, which discovers determination criteria by learning on its own using training data without supervision. In addition, the model training unit 154 may train the neural network model through reinforcement learning using feedback on whether the result of situation determination based on training is correct. Furthermore, the model training unit 154 may train the neural network model using training algorithms including error back-propagation or gradient descent.

When the neural network model is trained, the model training unit 154 may store the trained neural network model in the memory 155. Also, the model training unit 154 may store the trained neural network model in the memory of a server connected to the AI processing unit 150 through a wired or wireless network.

The data training unit 152 may further include a training data preprocessing unit (not illustrated) and a training data selection unit (not illustrated) so as to improve the results of analysis by a recognition model or reduce resources or time required to generate the recognition model.

The training data preprocessing unit may preprocess the acquired data so that the acquired data can be used for training for situation determination. For example, the training data preprocessing unit may process the acquired data into a preset format so that the model training unit 154 can use the acquired training data to perform training for image recognition.

Also, the training data selection unit may select data required for training between the training data acquired by the training data acquisition unit 153 and the training data preprocessed by the training data preprocessing unit. The selected training data may be provided to the model training unit 154.

The data training unit 152 may further include a model evaluation unit (not illustrated) to improve the results of analysis by the neural network model.

The model evaluation unit may input evaluation data to the neural network model, and may allow the model training unit 154 to perform retraining when the results of analysis, resulting from evaluation data, do not satisfy a certain criterion. In this case, the evaluation data may be predefined data for evaluating the recognition model. For example, the model evaluation unit may determine that the certain criterion is not satisfied when, of the results of analysis by the trained recognition model based on the evaluation data, the number or ratio of pieces of evaluation data for which an analysis result is not accurate exceeds a preset threshold.

The communication unit 157 may transmit the results of AI processing by the AI processor 151 to an external electronic device.

Meanwhile, although the illustrated AI processing unit 150 is described as being functionally divided into the AI processor 151, the memory 155, the communication unit 157, and the like, it is noted that the above-described components may be integrated into a single module and may be referred to as an AI module.

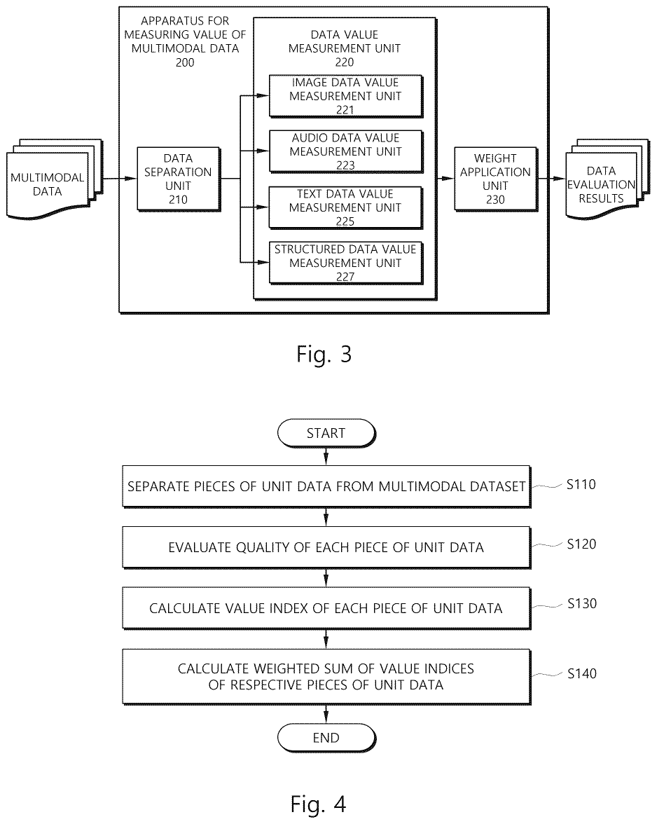

FIG. 3 is a functional block diagram illustrating an apparatus for measuring the value of multimodal data according to an embodiment.

The components of the apparatus for measuring the value of multimodal data according to an embodiment and principal functions of respective components are described as follows.

Referring to FIG. 3, an apparatus 200 for measuring the value of multimodal data may be configured to include a data separation unit (or a data separation processor) 210, a data value measurement unit (or a data value measurement processor) 220, and a weight application unit (or a weight application processor) 230.

The data separation unit 210 separates multimodal data, input to the apparatus 200 for measuring the value of multimodal data, depending on the types of respective pieces of unit data constituting the multimodal data, and delivers pieces of separated data to the data value measurement unit 220. Here, the data separation unit 210 delivers the pieces of separated unit data to value measurement units for respective pieces of unit data of the data value measurement unit 220 for respective unit data types. For example, assuming that the input multimodal data contains all of image data, audio data, text data, and structured data as pieces of unit data, the data separation unit 210 may deliver the pieces of unit data according to the type of unit data in such a way as to deliver the image data to a module that measures the value of the image data, deliver the audio data to a module that measures the value of the audio data, deliver the text data to a module that measures the value of the text data, and deliver the structured data to a module that measures the value of the structured data. In particular, the data separation unit 210 is configured to, when the input image data contains audio data, that is, when video data such as a moving picture is input, separate the audio data from the video data and independently assess the value of pieces of data. That is, the data separation unit 210 separates visual data and audio data from the video data, delivers the visual data to the module that measures the value of the image data, and delivers the audio data to the module that measures the value of the audio data.

The data value measurement unit 220 may be configured to check the quality indices of data based on criteria predefined for respective pieces of unit data and to measure the value of the unit data, thus measuring value for each piece of unit data depending on the type of each piece of data. The data value measurement unit 220 may verify the quality of each piece of unit data through a process of extracting quality indices preset for each piece of unit data, and thereafter digitize the value of data by assigning scores based on predefined criteria for respective extracted quality indices. The data value measurement unit 220 may be configured to include an image data value measurement unit 221, an audio data value measurement unit 223, a text data value measurement unit 225, and a structured data value measurement unit 227.

The image data value measurement unit 221 may measure the value of image input by evaluating the image input based on predefined criteria, for example, resolution, clarity, object recognition performance, and the like. When value is measured, value measurement for image data may be implemented using a generative artificial intelligence model, such as a Large Language Model (LLM), together with a computer vision-based value measurement method. For example, the image data value measurement unit 221 may measure the shape and degree of blur in an image using a computer vision technique, and may recognize objects in the image using the computer vision technique and a CNN model (e.g., You Only Look Once (YOLO) or the like). Further, the image data value measurement unit 221 may verify the quality of the image using the Large Language Model (LLM). Here, a method for verifying the quality of the image using the LLM may be implemented through prompt engineering. A prompt may be presented as a component for quantitatively determining indices. For example, the prompt may be presented as follows “Please measure the quality of this image. If the image is blurry, assign a score of 3, and if the image is clear, assign a score of 5. Additionally, if the number of recognized objects in the image is 5 or more, assign a score of 1, and if the number of recognized objects is less than 5, assign a score of 0. For a vehicle object, if a license plate is recognizable, assign a score of 4, and if the license plate is not recognizable, assign a score of 0, but the total score must not exceed a score of 10.”

The method for verifying the quality of an image using a Large Language Model (hereinafter referred to as ‘LLM’) which is one of generative artificial intelligence models, will be described in detail below.

The method for verifying the quality of an image using LLM may be performed through text-based evaluation and the application of quantified criteria. For this, LLM may function to analyze the characteristics of an image and calculate quality scores by utilizing prompt engineering.

For the method for evaluating the quality of an image, a computer vision technique is mainly used, but the quality of the image may be interpreted by utilizing LLM. This includes a scheme for generating text describing an image (description or caption) or evaluating input description.

Computer vision (CV)-based analysis is configured to perform clarity analysis (blur detection), noise removal, color contrast analysis, or the like, and LLM-based analysis is configured to perform the generation and evaluation of text description for the image.

Image quality evaluation using LLM may be performed using four methods, that is, a method for performing image caption generation and evaluation, a method for detecting objects in an image and performing quality evaluation, a method for performing image-text match evaluation, and a method for performing LLM-based user feedback collection and automated evaluation.

In the method for performing image caption generation and evaluation, LLM is caused to first generate the description of an image (hereinafter referred to as ‘caption’), and then evaluate the characteristics of the generated caption to assign quality scores thereto. For example, a caption for the image may be generated as, for example, “This image appears blurry, and background is unclear.” Then, the characteristics of the caption may be evaluated to use a prompt indicating the assignment of quality scores in such a way as to “Assign a score of 5 if the image is clear, assign a score of 2 if the image is blurry, and assign a score of 1 if the image contains much noise”. In a detailed example, the evaluation of image quality may be performed by inputting the prompt “Evaluate the quality of this image. If the image is blurry, assign a score of 3, if the image is clear, assign a score of 5, and if the image contains much noise, assign a score of 1, but the total score must not exceed a score of 10”.

In the method for detecting objects in an image and performing quality evaluation, objects in the image are first detected through LLM, and thus a description (caption) is generated. The result of detection may be output in the form of, for example, “Three persons are recognized in an image. The background is blurry.” Next, quality evaluation is performed based on the number of detected objects and clarity. For example, quality evaluation such as “Assign a score of 5 if an object is clearly recognized, and assign a score of 2 if the object is not clear” may be performed. In a specific example, a prompt such as “Assign a quality score based on the number of objects detected in the image. If the objects are clearly visible, assign a score of 5, and if the objects are blurry, assign a score of 2” may be input and used to perform quality evaluation on the image.

In the image-text match evaluation method, input text (description) and the content of an image are first compared with each other. For example, a prompt such as “The car in the image is blue.” may be used to verify whether the LLM has detected the blue car in the image. Next, quality scores are assigned based on whether the text and the image match each other. An example prompt may be “Assign a score of 5 if the text and the image match each other, and assign a score of 1 if they do not match each other.” In a detailed example, quality evaluation for the image may be performed by entering a prompt such as “Evaluate how well this text matches the image. Assign a score of 5 if the text and the image match completely, assign a score of 3 if they partially match, and assign a score of 1 if they do not match”.

The LLM-based user feedback collection and automated evaluation method may learn data personally evaluated by each user through LLM, thus improving a quality evaluation model. For example, when multiple users evaluate “This image is blurry” for a specific image, LLM may learn from this evaluation feedback, and may automatically evaluate the blurry image as a lower score.

Therefore, the method for verifying the image quality using LLM may perform more precise quality evaluation by combining an existing computer vision technique that analyzes the visual characteristics of each image with text-based evaluation. By means of this combination, the quality of images may be automatically analyzed and scores may be assigned in the analysis of submitted images and the evaluation of images posted on SNS in a public complaint reporting application (app) that is one of various application examples, which will be described later.

The audio data value measurement unit 223 may measure the value of input audio data including speech, music, and sound effects. When value is measured, an audio signal processing technique may be utilized. By utilizing the audio signal processing technique, the value of the audio data may be measured by classifying audio processing cases into the case where it is possible to separate background sound from the audio data, the case where it is possible to recognize speech from the audio data, the case where specific sounds such as car horns, collision noises, or siren are distinguishable from the audio data, and other cases.

The text data value measurement unit 225 may measure the value of text data input based on factors such as spelling accuracy, presence or absence of profanity, the degree of semantic consistency, or the like. Measurement of the value of text data input may be performed through a large language model (LLM) together with an existing data mining technique. Keywords may be extracted from input text data through a TD-IDF or TextRank algorithm based on the data mining technique, relevance between the purpose and the extracted keywords may be determined, and the value of the input text data may be analyzed using the large language model (LLM). A prompt for value analysis using the LLM may be presented as, for example, “Assign a score to the input text. If the text includes an accurate location, a detailed description of the condition, and a clearly defined issue, assign a score of 100. If these pieces of information are missing, assign a score of 10.”

The structured data value measurement unit 227 may measure the value of other structured data input based on whether time and location information is normalized. The other structured data may refer to time-series data typically collected based on sensors, and may be classified into the case whether a score of 1 is assigned when the time-series data is provided with structured characteristics and the case where a score of 0 is assigned when it is not provided with structured characteristics.

The weight application unit 230 may apply weights to value scores for respective pieces of unit data derived from the value measurement units for respective pieces of unit data (e.g., the image data value measurement unit 221, the audio data value measurement unit 223, the text data value measurement unit 225, and the structured data value measurement unit 227), and may calculate a weighted sum thereof. Here, the weights for value scores for respective pieces of unit data may be adjusted depending on the purpose of analysis of multimodal data or the usage purpose of the data. For example, when analysis target multimodal data is data used to train an artificial intelligence model, the weights of respective pieces of unit data may be adjusted depending on the purpose of training. Further, the weight application unit 230 may dynamically adjust the weights depending on the characteristics of training data of the artificial intelligence model. For example, when the value of image data is high, a weight for the output of the image data value measurement unit 221 may be set higher than those of audio data and text data, whereas when the value of text data is high, a weight for the output of the text data value measurement unit 225 may be set higher than those of image data and audio data.

Also, when the calculated final data value is lower than preset reference value, the weight application unit 230 may generate an alarm to re-input a multimodal dataset. For example, when the result of calculating the value of the input multimodal dataset is a score of 60 and a minimum data quality score required by a data processing system that receives and processes the corresponding multimodal dataset is 70, the measured value does not satisfy the minimum requirement condition. As a result, when data that does not satisfy the quality requirement is input to the data processing system, the result of data processing planned by the data processing system may not be output. Therefore, in order to solve this problem, the weight application unit 230 may notify a user who produced data, that is, a user who inputs the data to a value assessment device, that another piece of data needs to be input to the value assessment device by sending an alarm when the finally calculated value of the multimodal data is lower than a minimum required reference.

The illustrated components may not be essential, and thus the apparatus for measuring the value of multimodal data may be implemented to include more components or fewer components than those illustrated in the drawing. Such components may be implemented with hardware or software, or with a combination of hardware and software.

FIG. 4 is a diagram for explaining a method for measuring the value of multimodal data, performed by an apparatus for measuring the value of multimodal data, according to an embodiment.

The method for measuring the value of multimodal data according to the embodiment may perform a process of determining the value of application of a single dataset composed of multiple modalities to an artificial intelligence model so that the following processes are included in the process.

Referring to FIGS. 3 and 4, the method for measuring the value of multimodal data may include a process (S110) of separating pieces of unit data from an input multimodal dataset, a process (S120) of evaluating the quality index of each piece of unit data, a process (S130) of calculating the value index of each piece of unit data, and a process (S140) of calculating a weighted sum of value indices of respective pieces of unit data.

First, the method for measuring the value of multimodal data separates pieces of unit data from the input multimodal dataset in step S110. This process is the step of separating individual pieces of unit data. For example, the data separation unit 210 may separate a multimodal dataset composed of an image, text, and location information into pieces of unit data corresponding to one image, one piece of text data, and one piece of location information.

Next, the method for measuring the value of multimodal data evaluates the quality indices of the pieces of separated unit data in step S120. This process is the step of extracting quality indices (quality evaluation factors) and evaluating each unit data by the respective extracted quality indices for evaluating the value of each piece of unit data. For example, the data value measurement unit 220 may verify the quality of each piece of unit data through a process of extracting quality indices preset for each piece of unit data.

Taking a multimodal dataset composed of one piece of image data, one piece of text data, and one piece of location information data as an example, the quality of the image data may be verified by checking quality indices such as blur, resolution, and an object recognition result. In the case of the text data, the integrity of the text, such as spelling accuracy, the presence or absence of slang or vulgar expressions, or the degree of suitability relative to an intended purpose, is verified as the quality index. In the case of the location information data, the accuracy of the location information such as cross-checking with GPS coordinates in an image, or compliance with an address representation method may be verified as the quality index.

Next, the method for measuring the value of multimodal data calculates the value index of each piece of unit data in step S130. In this process, the data value measurement unit 220 digitizes the value of each piece of unit data based on criteria predefined for respective extracted quality indices, generated in step S120 of evaluating the quality index of each piece of unit data. For example, when each quality index is digitized as a score of 0 to 100, the data value measurement unit 220 may calculate the value of each piece of unit data by differently applying the quality index if necessary in such a way as to assign a score of 90 in the case where a photo has high resolution and sharpness and there is a recognized object and assign a score of 10 in the case where a photo is not clear due to blur or the like and low recognition performance is predicted.

Finally, the method for measuring the value of multimodal data calculates the weighted sum of the value indices of respective pieces of unit data in step S140. During this process, the weight application unit 230 may calculate the weighted sum of value scores of respective pieces of unit data derived in step S130 of calculating the value indices of respective pieces of unit data. Through this process, value scores for a single multimodal dataset may be calculated. In particular, during this process, when the importance of a specific data type among pieces of unit data such as those of an image, audio and text is high, the weight of the corresponding data type may be adjusted to be higher than those of other data types. For example, when the importance of the text data is high, the weights may be adjusted such that a weight of 20% is assigned to each of the image data, audio data, and structured data and a weight of 40% is assigned to the text data.

In addition, the method for measuring the value of multimodal data may identify not only the value indices of individual multimodal datasets but also the total data value index of all datasets if necessary. This process is implemented as the sum of the value indices of all datasets, and may be composed of procedures for obtaining the arithmetic mean of data value indices of respective pieces of unit data constituting each multimodal dataset.

In addition, the method for measuring the value of multimodal data may generate an alarm to re-input a multimodal dataset when the final data value calculated for individual multimodal datasets is lower than preset reference value, thus requesting the user to re-input a new multimodal dataset. In this way, the user may be warned or notified to input multimodal data that meets the minimum quality required by a specific system that receives and processes multimodal data to the specific system. In a public complaint handling system such as a public complaint reporting application (app), which will be described later, it is necessary to accept complaint reports prepared with high-quality data in order to process a complainant's public complaints smoothly. When the value of multimodal data included in a complaint report satisfies the minimum requirements, the content of the complaint may be easily understood in the public complaint handling process, thus allowing the content of the complaint to be handled promptly and with priority, with the result that there is the effect of reducing the workload of a complaint handling personnel.

Meanwhile, in the above-described method for measuring the value of multimodal data, step S120 of verifying the quality of each piece of unit data and step S130 of identifying the value index of each piece of unit data may be performed to be integrated into a process of extracting quality indices by which the quality of data can be determined for each type of separated unit data, assigning value scores based on criteria predefined for respective quality indices, and then calculating the value scores for respective pieces of data.

In the above description, steps, processes, or operations and detailed execution procedures of each process or operation may be subdivided into additional steps, processes or operations or may be integrated into fewer steps, processes, or operations according to embodiments of the present disclosure. Further, some steps, processes or operations may be skipped if necessary, and the order of steps or operations may be changed. Furthermore, each step or operation included in the aforementioned method for measuring the value of multimodal data may be implemented as a computer program and may be stored in a computer-readable recording medium, and each step, process or operation may be executed by a computer device.

Embodiments presented in the present disclosure may be utilized for the analysis of various types of multimodal data. The present disclosure presents examples of the application of complaint report data, received through a public complaint reporting app, to value analysis and examples of the application of data posted on social media service (SNS) to value analysis.

### Application Example 1: Analysis of Value of Complaint Report Data

Description will be made based on, for example, a public complaint reporting application (app), which is configured to allow users to report inconveniences or hazardous situations encountered in daily life to government agencies or responsible authorities in the form of complaints through a smartphone application (app). In this case, a complaint report is composed of pieces of information such as complaint evidence photos, complaint report text, the location of the complaint occurrence, and the time of the complaint occurrence. However, in the operation of such a public complaint reporting app, a low-quality evidence photo or inaccurate complaint report text may be one of factors making it difficult to handle reported safety-related complaints. In the present disclosure, the quality of reported complaints may be determined by a process of assessing the value of complaint report data through an apparatus for measuring the value of multimodal data and a method for measuring the value of multimodal data using the apparatus, and thus priority for handling the complaint or report may be determined. Alternatively, when the quality is low, notification indicating the low quality of the report data may be provided to the complainant before it is reviewed by a complaint handler, thus receiving the report again from the user. This process may result in simplification of the procedure for handling reports and improve the efficiency of complaint response. An example of implementation is described as follows.
1) A complaint reported by a user (complainant) through the public complaint reporting app is received (input). At this time, data provided by the complainant at the time of reporting is implemented as multimodal data, including a photo (image data), complaint report text (text data), complaint category (text data), time (structured data), and location information (structured data).
2) When report data is input, the data is classified depending on the type of each piece of unit data. Here, when video such as a moving picture is included in the input data, visual data, that is, image data, and audio data may be separated from video data.
3) For each piece of separated unit data, quality is measured for each piece of unit data.

As methods for measuring the quality of an input image, various methods may be applied. First, when generative artificial intelligence is utilized for image quality measurement, input data may be analyzed and evaluated using a preset prompt. Here, the prompt of the generative artificial intelligence may be composed of text for determining image resolution, image clarity, and reconizability of objects in the image. In another method, a computer vision technique may be utilized to measure image quality. When the computer vision technique is utilized, image clarity, image quality, and recognizeability of objects in the image may be determined through image analysis.

A method for measuring the quality of input audio may determine, through an audio signal processing technique, whether background sound is separable, whether speech is recognizable, or whether specific sounds (e.g., car horns, collision noise, siren or the like) are distinguishable.

A method for measuring the quality of input text (complaint report text and public complaint category) may be performed by analyzing value through a text mining technique or by measuring value through generative artificial intelligence such as a Large Language Model (LLM).

The value measurement method through the text mining technique may be performed by determining whether a keyword from complaint report text, entered by the user, matches user input category by extracting the corresponding keyword. In this case, a keyword extraction technique may be implemented using a text analysis algorithm such as TD-IDF or TextRank.

The method for measuring value through the generative artificial intelligence model may be performed by comparing complaint report text entered by the user through a prompt with text corresponding to the category of public complaint entered by the user, checking how closely related two pieces of text data are, and requesting an assessment of how specific the complaint report text is. For this purpose, few-shot learning may be used.

A method for measuring the value of input structured data may be performed to measure value by investigating whether a normalized representation method has been applied to time and location information.

In the case of value analysis of complaint report data, value analysis may be performed based on statistical data. The value of the corresponding public complaint may be analyzed by comparing the reported public complaint with the statistical data of complaint reports that have the same or similar complaint categories. For example, when there are many similar reports, a higher weight may be assigned to the corresponding complaint to obtain a higher value assessment. On the other hand, when there are few similar reports, a lower weight may be assigned to the corresponding complaint to obtain a lower value assessment.

Finally, the final value of the input data may be assessed by calculating the weighted sum of pieces of value information for respective pieces of unit data on which value assessment has been performed.

The value score of the reported public complaint based on the weighted sum may be calculated by the formula of w₁A+w₂B+w₃C+w₄D. Here, w₁+w₂+w₃+w₄=1 is satisfied, where A denotes the value score of the image, B denotes the value score of the complaint report text, C denotes the value score of metadata (structured data such as time and location), and D denotes a statistical value score.

### Application Example 2: Value Analysis of SNS Post Data

An SNS post may be multimodal data composed of pieces of data such as images (including still images and moving images), main text (text), hashtags (text), location information, and audio/music. The analysis of SNS posts can be utilized for various purposes, for example, the analysis of public safety, weather changes, and traffic changes based on post analysis. Also, through the analysis of SNS posts, whether a single post has a promotional or advertising purpose may be determined.

The value analysis of SNS post data may include the step of, when a user posts data on SNS, classifying the input post data depending on each data type, the step of measuring, for the classified data, the quality of each piece of unit data, and the step of finally assessing the value of the input data by calculating a weighted sum of pieces of value information for respective pieces of unit data on which value assessment is performed.

The post data uploaded by the user onto SNS may be implemented as multimodal data composed of photos, video, audio (music), time information, location information, main text, and hashtags.

First, the post data may be classified depending on each data type. For example, when input data is an image, the image may be immediately analyzed, but when the input data contains video (moving image), the input data may be separated into visual data and audio data, after which the visual data and the audio data are respectively analyzed.

Next, the quality of the separated data may be measured for the type of each piece of unit data.

The measurement of the quality of the visual data extracted from the video may be performed using a method for measuring the quality of an image out of the visual data by utilizing the generative artificial intelligence. The prompt of generative artificial intelligence may be composed of text including image quality, image clarity, recognizability of a landmark in the image, and identifiability of a hazard factor in the image. Alternatively, a computer vision technique may be utilized to measure image quality. Through computer vision technique-based image analysis technology, image quality, image clarity, recognizability of a landmark in the image, and identifiability of a hazard factor in the image may be determined.

The measurement of quality of audio data may be performed to identify whether background sound is separable, whether speech is recognizable, and whether specific sounds such as car horns, collision noise, siren or the like are distinguishable, through an audio signal processing technique.

The measurement of the value of main text and hashtags may be performed using the following three methods. First, a value analysis method based on a text mining technique is performed by extracting keywords from main text entered by a user and checking how closely the corresponding keywords match the hashtags. Here, an algorithm such as TD-IDF or TextRank may be used as the keyword extraction technique. Next, the value measurement method using a generative artificial intelligence (AI) model, such as LLM, may be performed by inputting the main text of the user and hashtags entered by the user and by verifying how closely related the two are using a prompt, or by requesting investigation as to how specific the main text is, thus assessing value. For this purpose, few-shot learning may be used. Finally, the promotional purpose of the main text and hashtags is determined using the value measurement method based on the text mining technique and the generative AI model such as the LLM.

The analysis of the value of structured data is performed by investigating whether a normalized representation method has been applied to time and location information.

A method for analyzing the value of statistical data performs value analysis depending on the statistical information of posts having hashtags similar/identical to the corresponding post. For example, when there are many similar posts, higher value may be assigned, whereas when there are fewer similar posts, lower value may be assigned.

Finally, the value of input data may be ultimately assessed by calculating a weighted sum of pieces of value information for respective pieces of unit data on which value assessment has been performed. By means of this, the value of each post and whether each post has a promotional purpose may be determined.

Meanwhile, when an input multimodal dataset is data related to a specific service (e.g., a complaint report via a public complaint reporting app, or an SNS post), the utility of data may be evaluated by analyzing statistical similarity through comparison with existing data that shares the same category or hashtags. In other words, when complaint report data or SNS post data is compared with the existing data having the same category or hashtag, as similarity to the existing data is higher, the input multimodal dataset is evaluated to have higher value, in other words, evaluated to be data with higher value.

Further, for text data, when value determination of the text data progresses using the LLM, the relevance between complaint report text and a public complaint category in the case of a public complaint reporting app, or between main text and hashtags in the case of SNS posts, may be determined. Furthermore, by checking how frequently similar data is input within the same time slot, statistical value may be assessed. In particular, in the case of the public complaint reporting app, statistical value may be determined based on statistical information of complaint reports in similar categories, and in the case of SNS posts, the statistical value may be determined based on the statistical information of the posts with identical or similar hashtags.

The above-described embodiments are combinations of components and features of the present disclosure in certain forms. Each component or feature should be considered optional unless explicitly stated otherwise. Each component or feature may be implemented independently without being combined with other components or features. In addition, it is also possible to combine some components and/or features to constitute an embodiment of the present disclosure. The sequence of operations described in the embodiments of the present disclosure may be changed. Some components or features in one embodiment may be included in another embodiment, or may be replaced with corresponding components or features in another embodiment. It is apparent that claims not explicitly cited in dependency relationships in the claims may be combined to form embodiments or may be included as new claims through amendments after filing.

The embodiments according to the present disclosure may be implemented by various means, for example, hardware, firmware, software, or a combination thereof. In the case of hardware implementation, an embodiment of the present disclosure may be implemented by one or more application specific integrated circuits (ASICs), digital signal processors (DSPs), digital signal processing devices (DSPDs), programmable logic devices (PLDs), field programmable gate arrays (FPGAs), processors, controllers, microcontrollers, microprocessors, or the like.

In the case of implementation by firmware or software, an embodiment of the present disclosure may be implemented in the form of modules, procedures, functions, or the like that perform the functions or operations described above. Software code may be stored in memory and executed by a processor. The memory may be located either inside or outside the processor and may exchange data with the processor by various known means.

It will be apparent to those skilled in the art that the present disclosure may be embodied in other specific forms without departing from the essential features of the present disclosure. Therefore, the above detailed description should not be construed as restrictive in all aspects, but rather should be considered illustrative. The scope of the present disclosure should be determined by reasonable construction of the accompanying claims, and all modifications within the equivalent scope of the disclosure are included within the scope of the present disclosure.

What is claimed is:

1. An apparatus for measuring a value of multimodal data based on unit data characteristics, comprising:
a data separation processor configured to separate pieces of unit data from an input multimodal dataset;
a data value measurement processor configured to evaluate a quality index of each piece of unit data based on the first preset criteria, and calculate a value index of each piece of unit data based on the second preset criteria depending on the quality index of each piece of unit data; and
a weight application processor configured to calculate final data value by applying a weight to the value index of each piece of unit data calculated by the data value measurement processor.

2. The apparatus as claimed in claim 1, wherein the data value measurement processor is configured to:
in response to the unit data being image data, assess value based on resolution, clarity, or object recognition performance,
in response to the unit data being audio data, assess value depending on whether a background sound is removable or whether a specific sound is recognizable,
in response to the unit data being text data, assess value based on spelling accuracy, presence or absence of profanity, or a degree of semantic consistency, and
in response to the unit data being structured data, assess value based on whether time information and location information are normalized.

3. The apparatus as claimed in claim 2, wherein the data value measurement processor is configured to:
in response to value assessment being performed on the image data, assess value based on a prompt as to quality of an image, clarity of the image, or object recognizability using a generative artificial intelligence model,
in response to value assessment being performed on the audio data, assess value depending on whether a background sound is removable or whether a specific sound is recognizable by utilizing an audio signal processing technique, and
in response to value assessment being performed on the text data, assess value by utilizing a text mining technique.

4. The apparatus as claimed in claim 1, wherein the weight application processor is configured to adjust a weight of each piece of unit data depending on a training purpose of an artificial intelligence model.

5. The apparatus as claimed in claim 1, wherein the weight application processor is configured to dynamically adjust a weight depending on a characteristic of training data of an artificial intelligence model.

6. The apparatus as claimed in claim 1, wherein the data separation processor is configured to, in response to the image data including audio data, independently assess value by separating the audio data from the image data.

7. The apparatus as claimed in claim 1, wherein the weight application processor is configured to, in response to the calculated final data value being lower than preset reference value, generate an alarm to re-input a multimodal dataset.

8. A method for measuring value of multimodal data based on unit data characteristics, comprising:
separating, by a data separation processor, pieces of unit data from an input multimodal dataset;
evaluating, by a data value measurement processor, a quality index of each piece of unit data based on the first preset criteria;
calculating, by the data value measurement processor, a value index of each piece of unit data based on the second preset criteria depending on the quality index of each piece of unit data; and
calculating, by a weight application processor, final data value by applying a weight to the value index of each piece of unit data.

9. The method as claimed in claim 8, wherein evaluating the quality index of each piece of unit data based on the first preset criteria comprises:
in response to the unit data being image data, assessing value based on resolution, clarity, or object recognition performance,
in response to the unit data being audio data, assessing value depending on whether a background sound is removable or whether a specific sound is recognizable,
in response to the unit data being text data, assessing value based on spelling accuracy, presence or absence of profanity, or a degree of semantic consistency, and
in response to the unit data being structured data, assessing value based on whether time information and location information are normalized.

10. The method as claimed in claim 9, wherein evaluating the quality index of each piece of unit data based on the first preset criteria further comprises:
performing quality evaluation using a generative artificial intelligence model, and
analyzing quality of each piece of unit data that is input through a preset prompt.

11. The method as claimed in claim 8, wherein calculating the value index of each piece of unit data based on the second preset criteria depending on the quality index of each piece of unit data comprises:
calculating the quality index of each piece of unit data by converting the quality index into a score within a range from 0 to 100.

12. The method as claimed in claim 8, wherein calculating the final data value by applying the weight to the value index of each piece of unit data comprises:
in response to importance of a specific data type among pieces of unit data being high, adjusting a weight of the corresponding data type.

13. The method as claimed in claim 8, further comprising:
quantitatively evaluating total quality of an entire input multimodal dataset by calculating an arithmetic mean of the entire input multimodal dataset.

14. The method as claimed in claim 12, wherein separating the pieces of unit data from the input multimodal dataset comprises:
in response to image data included in the multimodal dataset including audio data, separating the audio data from the image data.

15. The method as claimed in claim 8, further comprising:
in response to the calculated final data value being lower than preset reference value, generating an alarm to re-input a multimodal dataset.
